(19) United States
(12) Patent Application Publication
(10) Pub. No.: US 2010/0220101 A1
(43) Pub. Date: Sep. 2, 2010

(54) MULTIPLE GRAPHICS PROCESSING UNIT SYSTEM AND METHOD

(75) Inventors: David Wyatt, San Jose, CA (US); Manish Modi, San Jose, CA (US)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA CORPORATION, Santa Clara, CA (US)

(21) Appl. No.: 12/395,526

(22) Filed: Feb. 27, 2009

(51) Int. Cl. G06F 15/16

(52) U.S. Cl. 345/502

(57) ABSTRACT

Systems and methods for utilizing multiple graphics processing units for controlling presentations on a display are presented. In one embodiment, a dual graphics processing system includes a first graphics processing unit for processing graphics information; a second graphics processing unit for processing graphics information; and a component for controlling switching between said first graphics processing unit and said second graphics processing unit. In one embodiment, the component for controlling complies with appropriate panel power sequencing operations when coordinating the switching between the first graphics processing unit and the second graphics processing unit.

### FIELD OF THE INVENTION

The present invention relates to the field of displaying presentations associated with graphics processing units.

### BACKGROUND OF THE INVENTION

Electronic systems and circuits have made a significant contribution towards the advancement of modern society and are utilized in a number of applications to achieve advantageous results. Numerous electronic technologies such as digital computers, calculators, audio devices, video equipment, and telephone systems facilitate increased productivity and cost reduction in analyzing and communicating data, ideas and trends in most areas of business, science, education and entertainment. Frequently, these activities often involve the presentation of various graphics information on a display.

Graphics applications associated with the display presentations can have different characteristics and features. For example,

Displays typically have panel power sequencing specifications that indicate signal activation timing requirements. For example, the standards panel working group (SPWG) indicates general mechanical and interface specifications (e.g., SPWG spec, http://www.spwg.org) for displays used in note book computers. FIG. 1A is an exemplary timing diagram for one panel power sequence for a LCD power control signal (LCD_EN), active LVDS signals (LVDS) and a LCD backlight control (B/L). The timing requirements between the transitions in the signals are typically defined by the display manufacturer.

### SUMMARY

Systems and methods for utilizing multiple graphics processing units for controlling presentations on a display are presented. In one embodiment, a dual graphics processing system includes a first graphics processing unit for processing graphics information; a second graphics processing unit for processing graphics information; and a component for controlling switching between the first graphics processing unit and the second graphics processing unit. In one embodiment, the component for controlling complies with appropriate panel power sequencing operations when coordinating the switching between the first graphics processing unit and the second graphics processing unit.

### DESCRIPTION OF THE DRAWINGS

The accompanying drawings, which are incorporated in and form a part of this specification, are included for exemplary illustration of the principles of the present and invention and not intended to limit the present invention to the particular implementations illustrated therein. The drawings are not to scale unless otherwise specifically indicated.

FIG. 1A is an exemplary timing diagram for one panel power sequence.

FIG. 1B is a block diagram of an exemplary computer system in accordance with one embodiment of the present invention.

FIG. 2 is a block diagram of one exemplary implementation of a MUX for controlling switching between the first graphics processing unit and the second graphics processing unit.

FIG. 3 is a block diagram of an exemplary panel power sequence control component in accordance with one embodiment of the present invention.

FIG. 4 is a block diagram of an exemplary computer system in which one processor controls a backlight intensity while another processor controls backlight enablement and other display interface signals in accordance with one embodiment of the present invention.

FIG. 5 is an exemplary timing diagram of control signals in accordance with one embodiment of the present invention.

FIG. 6 is a block diagram of exemplary dual graphics processing method in accordance with one embodiment of the present invention.

FIG. 7 is a flow chart of another exemplary dual graphics processing method in accordance with one embodiment of the present invention.

FIG. 8 is a flow chart of exemplary graphics processing unit change over process with powering up and down the graphics processing units in accordance with one embodiment of the present invention.

FIG. 9 is a flow chart exemplary of another graphics processing unit change over process in accordance with one embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one ordinarily skilled in the art that the present invention may be practiced without these specific details. In other instances, well known methods, procedures, components, and circuits have not been described in detail as not to unnecessarily obscure aspects of the current invention.

Some portions of the detailed descriptions which follow are presented in terms of procedures, logic blocks, processing, and other symbolic representations of operations on data bits within a computer memory. These descriptions and representations are the means generally used by those

It should be borne in mind, however, that all of these and similar terms are associated with the appropriate physical quantities and are merely convenient labels applied to these quantities. Unless specifically stated otherwise as apparent from the following discussions, it is appreciated that throughout the present application, discussions utilizing terms such as “processing”, “computing”, “calculating”, “determining”, “displaying” accessing,” “writing,” “including,” “storing,” “transmitting,” “traversing,” “associating,” “identifying” or the like, refer to the action and processes of a computer system, or similar processing device (e.g., an electrical, optical, or quantum, computing device), that manipulates and transforms data represented as physical (e.g., electronic) quantities. The terms refer to actions

Portions of the detailed description that follows are presented and discussed in terms of a method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available

Some embodiments may be described in the general context of computer-executable instructions, such as program modules, executed by one or more computers or other devices. Generally, program modules include routines, programs, objects, components, data structures, etc, that perform particular tasks or implement particular abstract data types. Typically the functionality of the program modules may be combined or distributed as desired in various embodiments.

The present invention facilitates efficient effective utilization of multiple graphics processing units or hybrid graphics processing system. In one embodiment, a dual graphics processing system includes a first graphics processing unit for processing graphics information, a second graphics processing unit for processing graphics information, and a component for controlling switching between the first graphics processing unit and the second graphics processing unit. In one exemplary implementation, the component for controlling switching between the first graphics processing unit and the second graphics processing unit includes a multiplexer that forwards display component signals from the first graphics processing unit and the second graphics processing unit in accordance with a graphics processing unit selection indication. The component for controlling conforms to panel power sequencing when coordinating the switching

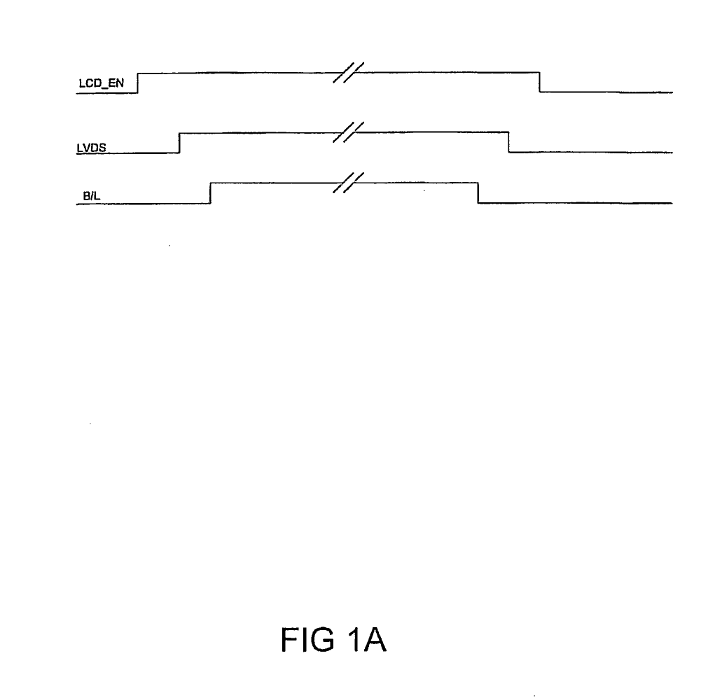

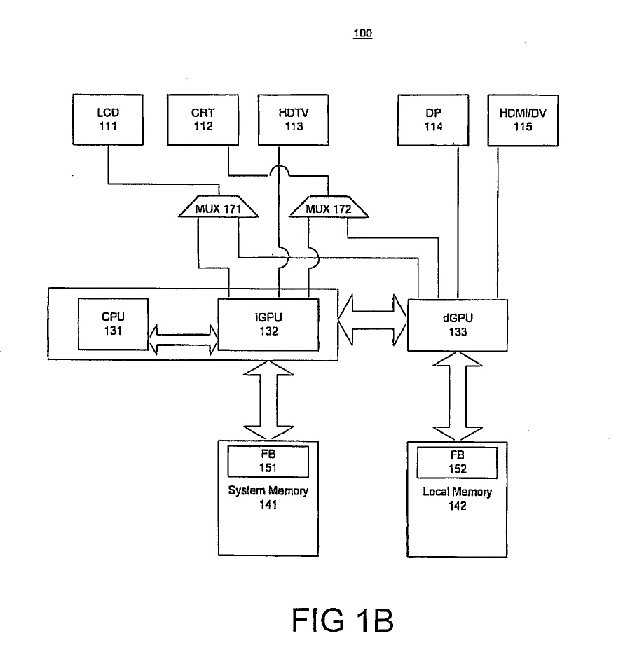

FIG. 1B is block diagram of exemplary computer system 100 in accordance with one embodiment of the present invention. Computer system 100 includes central processing core (CPU) 131, integrated graphics processing unit 132 (iGPU), discrete graphics processing unit (dGPU) 133, system memory 141, local memory 142, liquid crystal display (LCD) 111, cathode ray tube display (CRT) 112, high definition television display (HDTV) 113, display port (DP) 114, high definition multimedia interface/digital video interface (HDMI/DVI) 115, multiplexer (MUX) 171 and multiplexer (MUX) 172. System memory 141 includes frame buffer (FB) 151 and local memory 142 includes frame buffer (FB) 152. In one embodiment, iGPU 132 is integrated with CPU 131.

The components of exemplary computer system 100 cooperatively operate to arbitrate control of a display between two graphics controllers. CPU 131 performs core central processing operations. First graphics processing unit iGPU 132 processes graphics information. Second graphics processing unit dGPU 133 processes graphics information. MUX 171

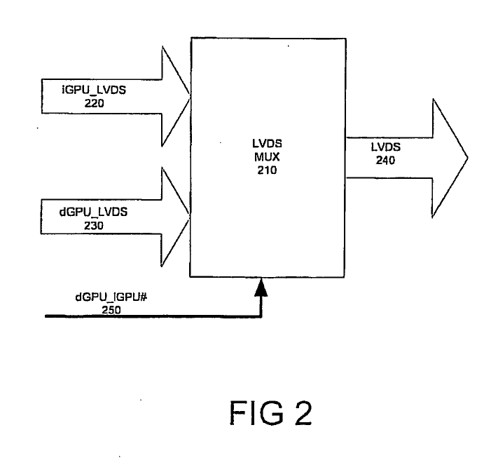

It is appreciated the component for controlling switching between the first graphics processing unit and the second graphics processing unit can be implemented in a variety of ways. FIG. 2 is a block diagram of one exemplary implementation of MUX 210 for controlling switching between the first graphics processing unit and the second graphics processing unit. MUX 210 receives graphics signals from iGPU (e.g., iGPU_LVDS, etc.) and dGPU (e.g., dGPU_LVDS, etc.) and forwards one set of graphics signals in accordance with selection indication (e.g., DGPU_IGPU#) and selects which processor's set of graphics signals are forwarded to a panel. In the illustrated example the graphics signals include low voltage differential signals (LVDS).

In one embodiment, the LVDS signals are muxed but the backlight intensity (e.g., pulse width modulation intensity control and inverter enable) is continued to be controlled by one processor (e.g., the iGPU). In some exemplary implementations, the backlight inverter and CCRL backlight source can take a considerable amount of time to charge to full intensity and the present embodiment facilitates reduction of visual artifacts of fading or flashing by providing more persistent backlight control.

The component for controlling switching between the first graphics processing unit and the second graphics processing unit can be implemented in a variety of ways can also include components for controlling display activation. In one exemplary implementation, the components for controlling display activation can facilitate compliance with panel power sequence operations and requirements. In one embodiment, the component for controlling switching between the first graphics processing unit and the second graphics processing unit includes a panel power sequence control component comprising a first graphics processing unit display enable component for coordinating display component enablement indication from the first graphics processing unit with a graphics processing selection

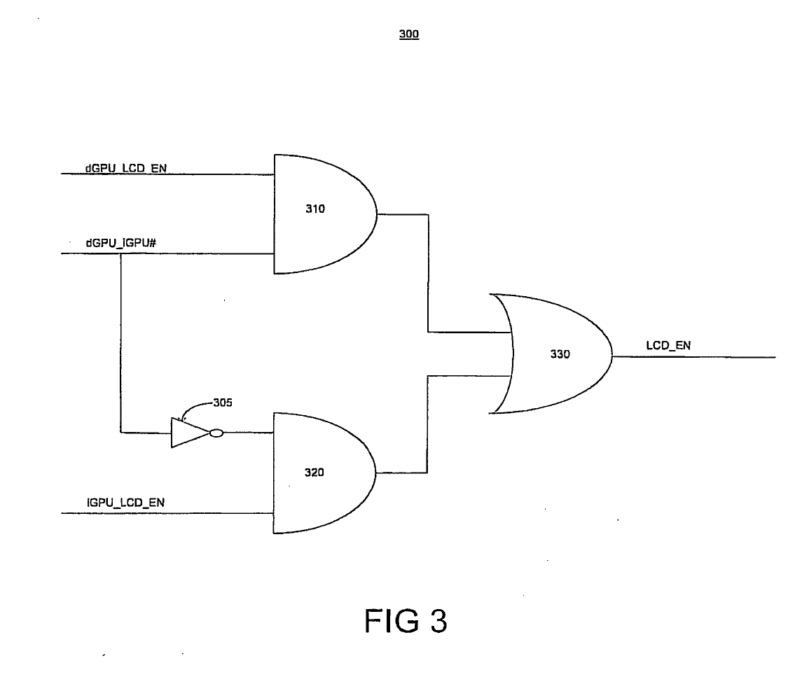

FIG. 3 is a block diagram of exemplary panel power sequence control component 300 in accordance with one embodiment of the present invention. A first graphics processing unit display enable component includes AND gate 320 for coordinating display component enablement indication IGPU_LCD_EN from the first graphics processing unit with a graphics processing unit selection indication DGPU_IGPU#. In one embodiment, the indication DGPU_IGPU# is inverted before being fed into AND gate 320. The second graphics processing unit display enable component includes AND gate 310 for coordinating display component enablement indication DGPU_LCD_EN from the second graphics processing unit with the graphics unit processing selection indication DGPU_IGPU#. The display component enable generation component OR gate 330 generates a display component enable signal LCD_EN in accordance with output of the first graphics processing unit display enable component AND gate 310 and

In one embodiment, components similar to exemplary panel power sequence control component 300 can also be utilized to forward GPU backlight control signals (e.g. Pulse Width Modulated Intensity Control and Inverter Enable). Power panel sequencing logic can sequence the backlight as well as power control.

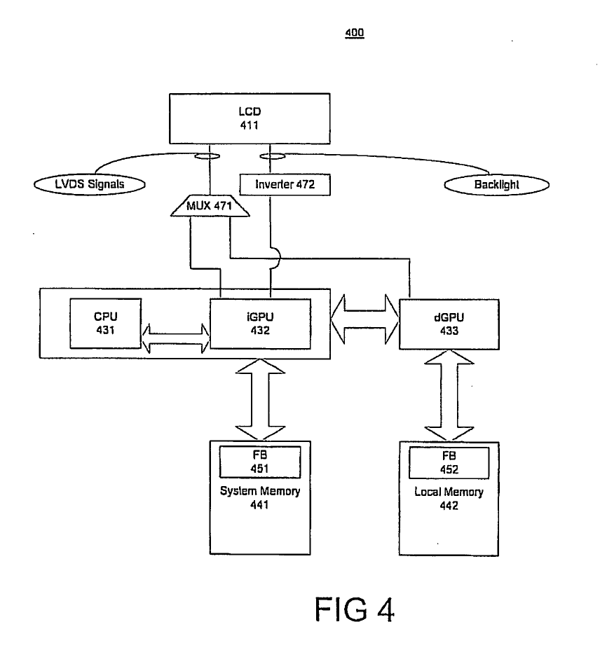

FIG. 4 is a block diagram of exemplary computer system 400 in accordance with one embodiment of the present invention. Exemplary computer system 400 is similar to exemplary computer system 100 except backlight control is different. In exemplary computer system 400, while the backlight enable is driven by the discrete graphics processing unit, a backlighting intensity signal is driven by the internal graphics processing unit even after control of other display signals is transferred to the discrete graphics processing unit. Exemplary computer system 400 includes central processing core (CPU) 431, integrated graphics processing unit 432 (iGPU), discrete graphics processing unit (dGPU) 433, system memory 441, local memory 442, liquid crystal display (LCD) 411, multiplexer (MUX) 471 and inverter 472. System memory 441 includes frame buffer (FB) 451 and local memory 442 includes frame buffer (FB) 452.

The components of exemplary computer system 400 cooperatively operate to arbitrate control of a display between two graphics controllers. CPU 431 performs core central processing operations. First graphics processing unit iGPU 432 processes graphics information. Second graphics processing unit dGPU 433 processes graphics information. MUX 471 controls switching between the iGPU 432 and the dGPU 433. MUX 471 forwards display component signals from the first graphics processing unit and the second graphics processing unit in accordance with a graphics processing unit selection indication. System memory 441 and local memory 442 store information. LCD 411 display information. Inverter 472 inverts backlight control signals from iGPU 432 (e.g. pulse width modulated intensity control). In one embodiment, the backlight enable signal (not shown) is provided to inverter 472 from the dGPU 433.

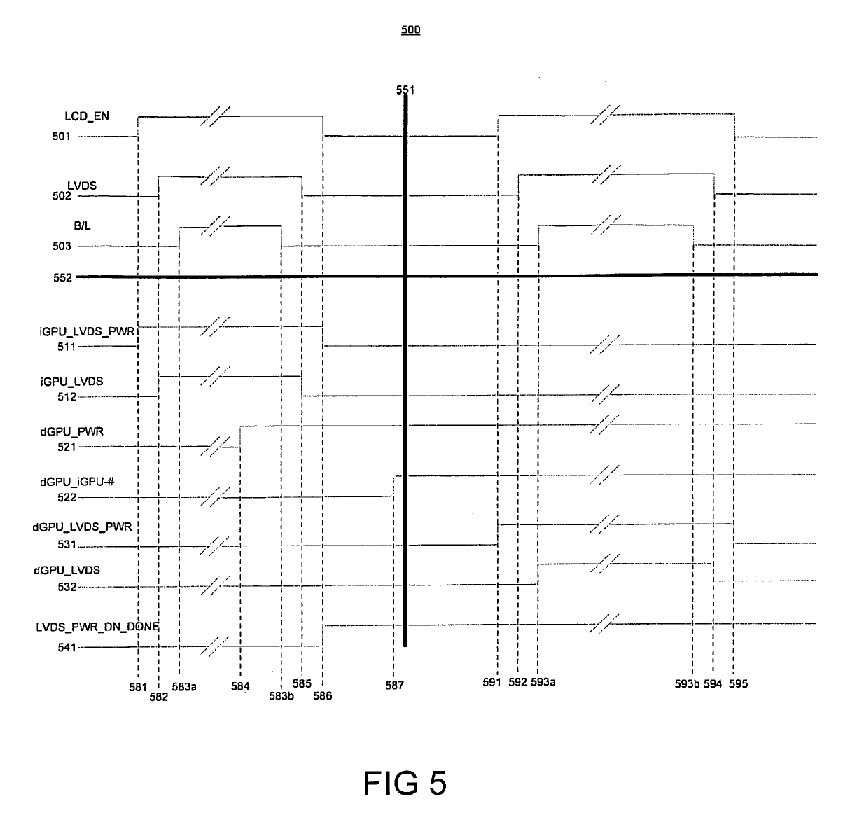

FIG. 5 is an exemplary timing diagram 500 of control signals in accordance with one embodiment of the present invention. The timing diagram 500 includes signals that are fed into and forwarded out of a component for controlling switching between the first graphics processing unit and the second graphics processing unit (e.g., MUX 171, 471, 172, etc.). In one embodiment, timing diagram 500 illustrates states of signals when an iGPU generated signals are being forwarded to a display (e.g. the state of

In one exemplary implementation, signals iGPU-LVDS-PWR 511 and dGPU-LVDS-PWR 531 are fed into a panel power sequence control component (e.g., 300 in FIG. 3) and signal LCD_EN 501 is forwarded to a display while signals 512 and 532 are fed into a (e.g., MUX 171, 210, 471, etc.) and signals 502 are forwarded from the MUX to the display (e.g., LCD 111, etc.). In one embodiment, iGPU-LVDS-PWR 511 corresponds to iGPU_LCD_EN fed into AND gate 320 and dGPU-LVDS-PWR 531 corresponds dGPU_LCD_EN fed into AND gate 310 and LCD_EN 501 corresponds to LCD_EN out of OR gate 330. Thus, the display essentially receives signals LCD_EN 501 and LVDS 502 and these signals appear as if coming from a single graphics processing unit, while signals 511, 512, 531 and 532 are in essence driving the display depending upon whether iGPU or dCPU is the active graphics processing unit. The iGPU LVDS power (iGPU-LVDS_PWR) signal is activated at time 581 and the LCD enable (LCD_EN) signal is forwarded to the LCD. The iGPU is the active device and after an appropriated panel power sequence time has passed the iGPU-LVDS signals are activated at time 582. It is appreciated the present illustration is utilized to indicted the LVDS signals are activated rather than any particular logic

When the system receives a signal indicating a transition from the iGPU to the dGPU should begin, the dGPU power up signal (dGPU_PWR) is triggered at time 584 to enable or power up the dGPU itself in anticipation of a change from the iGPU control to dGPU control. The LCD mode and timings are established on the dGPU while the dGPU LVDS interface is still off. A panel power down sequence is commenced on the iGPU. At time 585 the iGPU_LVDS signals 512 are deactivated resulting in the LVDS signals 502 forwarded to the display becoming deactivated. At time 586 the IGPU_LVDS_PWR signal 511 is deactivated and correspondingly LCN_EN signal 501 is also deactivated. Selection indication dGPU_iGPU# signal 522 is changed from a state indicating the iGPU is forwarding signals to a state indicating the dGPU is going to forward signals and the MUX in turn will forward the dCPU signals instead of the iGPU signals.

With reference still to FIG. 5, the dGPU is instructed (e.g., by a driver, etc.) to begin panel power sequence and the dGPU signals are utilized after the transition at line 551. The dGPU_LVDS_PWR signal is activated at time 591 resulting in LCD_EN signal 501 being activated. At time 592 dGPU_LVDS signal is activated which in turn means the LVDS signal 502 is activated. At time 593a the backlight signal is reactivated and deactivated at time 593b. It is appreciated the backlight can be driven in accordance with a variety of scenarios. The backlight can deactivated and reactivated to be driven by the dGPU or some of the backlight signals (e.g., pulse width modulated intensity and inverter enable) can be again be driven by the iGPU even when the dGPU is driving the backlight enable and the LVDS signals. At time 594 the dGPU_LVDs signal is deactivated and in turn the LVDS signals 502 are deactivated. At time 595 the dGPU_LVDS_PWR signal is deactivated resulting in the LCN_EN being deactivated.

In one embodiment, when the deactivation of the iGPU driving of the display enable (e.g., LCD_EN) occurs the operations wait for the process to complete from an Operating System perspective. In one embodiment, the LVDS_PWR_DOWN_DONE 541 signal is utilized to trigger the selection indication signal dGPU_iGPU# signal at time 586 instead of 587. Utilizing the LVDS_PWR_DOWN_DONE 541 signal reduces the possibility that the OS is performing some other processing and takes some time to

It is appreciated that while an iGPU to dGPU transition is illustrated in FIG. 5, a similar process can be performed for a dGPU to iGPU transition. In one embodiment the entities are reversed. In addition, after an initial power up of the iGPU the iGPU can remain powered up (e.g., other things being equal) rather than powering up and down that may be associated with a dGPU. For example, if a hybrid system included a iGPU in a CPU and a dGPU, since the CPU remains powered up the iGPU can remain powered up while dGPU is powered down.

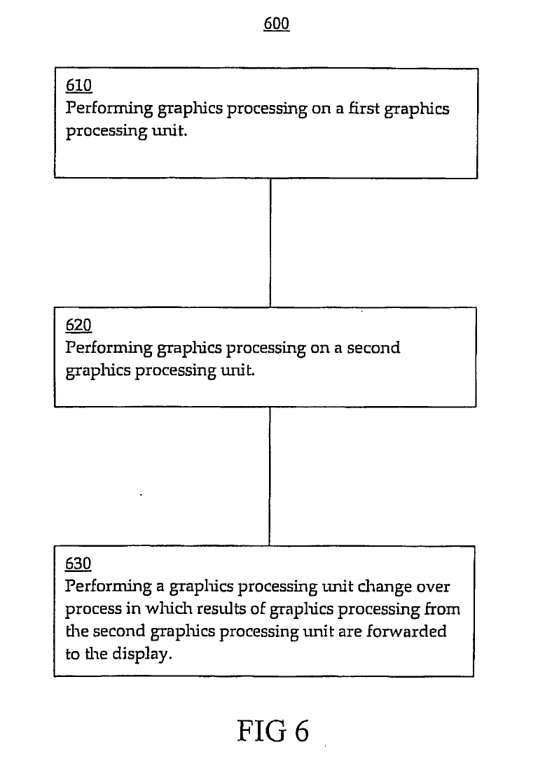

FIG. 6 is a block diagram of exemplary dual graphics processing method 600 in accordance with one embodiment of the present invention. In one embodiment there is an agent which is going to help coordinate the process or transaction by talking to drives associated with multiple processors. In one exemplary implementation, the agent is “hybrid” software instructions embedded on a computer readable medium and the instructions direct driver operations on a processor.

In operation 610, graphics processing is performed on a first graphics processing unit and the results are forwarded to a display. It is appreciated a variety of graphics processing applications can be performed. For example, 2D graphics processing, 3D graphics processing, video processing, etc.

In operation 620, graphics processing is performed on a second graphics processing unit. In one embodiment, the second graphics processing unit is essentially working on the same graphics processing application as the first graphics processing unit in anticipation of a change over. By working on the same graphics processing application the second graphics processing unit can be ready with information to make the change over appear relatively seamless from a viewing user perspective.

At operation 630, a graphics processing unit change over process is performed in which results of graphics processing from the second graphics processing unit are forwarded to the display instead of results from the first graphics processor. In one embodiment the graphics processing unit change over process includes panel power sequencing operations. It is appreciated that present process is readily adaptable to a variety of change over interactions.

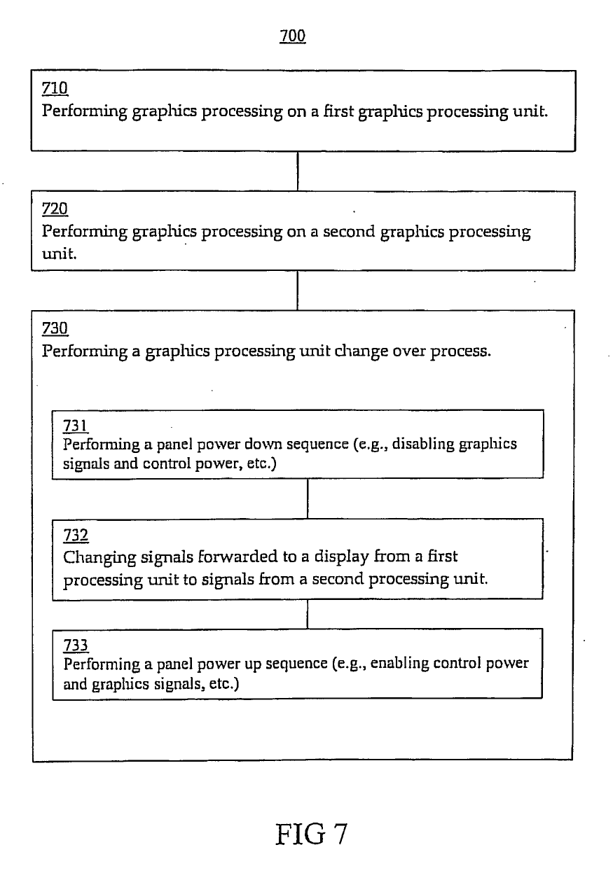

FIG. 7 is a flow chart of exemplary dual graphics processing method 700 in accordance with one embodiment of the present invention. Dual graphics processing method 700 is similar to dual graphics processing method 600.

In operation 710 graphics processing is performed on a first graphics processing unit, in operation 720 graphics processing is performed on a second graphics processing unit, and in operation 730 a change over process is performed.

The change over process in operation 730 includes panel power sequencing operations. In operation 731a panel power down sequence is performed. In one exemplary implementation, the panel power down sequence includes disabling communication of graphics information signals (e.g., LVDS, etc.) and control power (e.g., LCD_EN, etc.) to a panel interface. In operation 732 signals forwarded to a display from a first processing unit are changed to signals from a second processing unit. It is appreciated a variety of components can be utilized to in the change over (e.g., a switching component, MUX, crossbar, routing component, etc.). In operation 733 a panel power up sequence is performed. In one exemplary implementation, the panel power up sequence includes enabling control

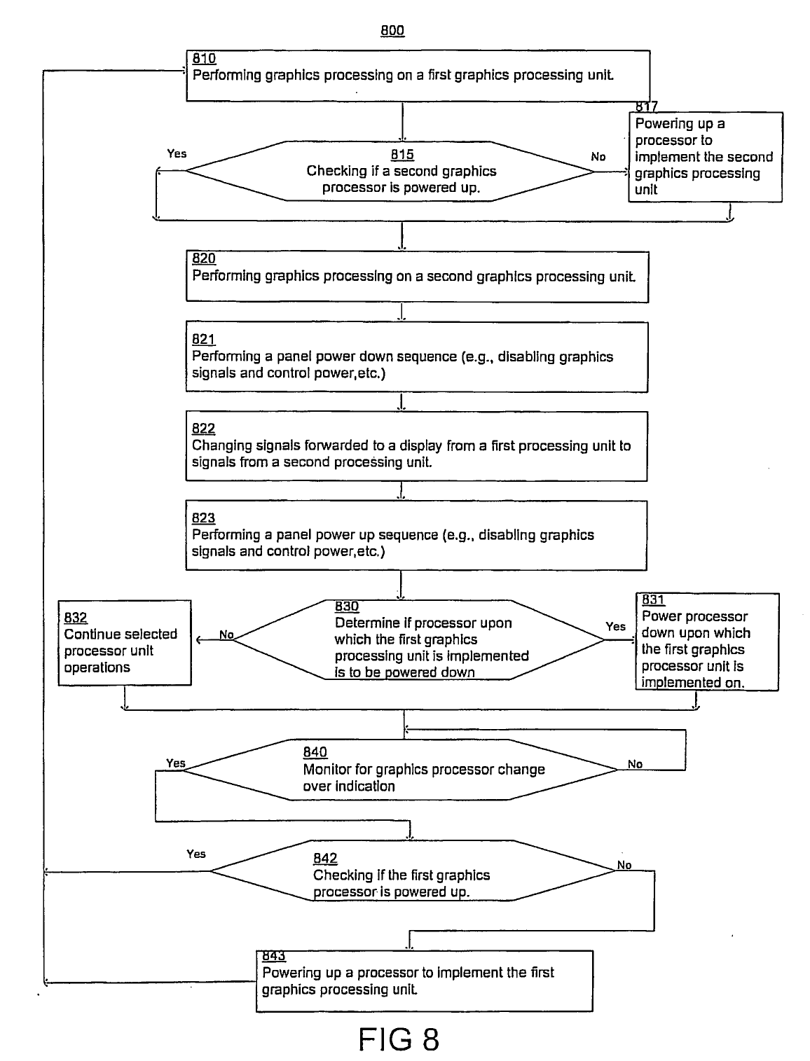

The graphics processing unit change over process can include powering up and down the graphics processing units. FIG. 8 is a flow chart of exemplary graphics processing unit change over process 800 with powering up and down the graphics processing units in accordance with one embodiment of the present invention. Graphics processing unit change over process 800 includes powering up a graphics processing unit; checking if a another graphics processing unit is powered up; powering up the other graphics processing unit if not already powered up; and changing information forwarded to a display from the first graphics processing unit to the second graphics processing unit.

In operation 810, graphics processing is performed on a first graphics processing unit.

Operation 815 checks if a second graphics processor is powered up. If powered up the process proceeds to operation 820. If not powered up the process proceeds to operation 817.

In operation 817, a processor is powered up to implement the second graphics processing unit. Powering up the processor can include a cold power, wake up from idle state, enabling graphics processing capabilities on a processor that is otherwise already powered up. In one exemplary implementation integrated power processing capabilities are enabled on a processor (e.g., CPU, etc.) that is otherwise powered up.

In operation 820, graphics processing is performed on a second graphics processing unit.

A panel power down sequence is performed in operation 821. In one embodiment the panel power down sequence includes disabling signals on the display interface (e.g., graphics signals, control power etc.). In one exemplary implementation, the panel power down sequence is performed in accordance with the panel power sequence instructions from the panel vendor or manufacturer.

At operation 822, signals forwarded to a display are changed from a first processing unit to signals from a second processing unit. Again, it is appreciated a variety of components can be utilized to in the change over (e.g., a switching component, MUX, crossbar, routing component, etc.).

A panel power up sequence (e.g., disabling graphics signals and control power, etc.) is performed at operation 823. In one embodiment the panel power up sequence includes enabling signals on the display interface (e.g., graphics signals, control power etc.). In one exemplary implementation, the panel power updown sequence is performed in accordance with the panel power sequence instructions from the panel vendor or manufacturer.

In operation 830, a determination is made if a processor upon which the first graphics processing unit is implemented is to be powered down. In one exemplary implementation if the first graphics processing unit is implemented in an integrated processor (e.g., CPU, etc.) the integrated processor is not powered down and if the first graphics processing unit is implemented in a discrete processor (e.g., CPU, etc.) the discrete processor is powered down. If the processor is to not to be powered down the process proceeds to operation 832. If the processor is to be powered down the process proceeds to operation 831.

At operation 831 power down is performed upon the processor which the first graphics processor unit is implemented on. The power down can include full power down, partial power down, sleep mode, etc. The process proceeds to operation 840.

At operation 832 selected processor unit operations are continued. In one exemplary implementation in which the first graphics processing unit is implemented in an integrated processor (e.g., CPU, etc.), processing operations other than integrated graphics processing operations are continued to be performed.

In operation 840 monitoring for graphics processor change over indication is performed. The graphics processor change over indication can come from a user, from a graphics application, from an indication of a particular type of graphics processing being performed (e.g., high performance such as video etc. versus low performance such as text, etc.), from detection of an environmental condition, etc. If there is not indication the process continues to monitor in operation 840. If there is a graphics processor change over indication the process proceeds to operation 842

At operation 842 a check is made if the first graphics processor is powered up. If the first graphics processor is powered up the process proceeds back to operation 810. If the first graphics process is not powered up the process proceeds to operation 843.

At operation 843 the first graphics processor is powered up and the process returns to operation 810.

It is appreciated the present graphics processing unit change over processes can be implemented in a system in which the first graphics processing unit is an internal graphics processing unit and the second graphics processing unit is a discrete graphics processing unit. In one embodiment, a panel control signal transmitted from the first graphics processing unit is utilized as a feedback event to trigger the changing to a second graphics processor.

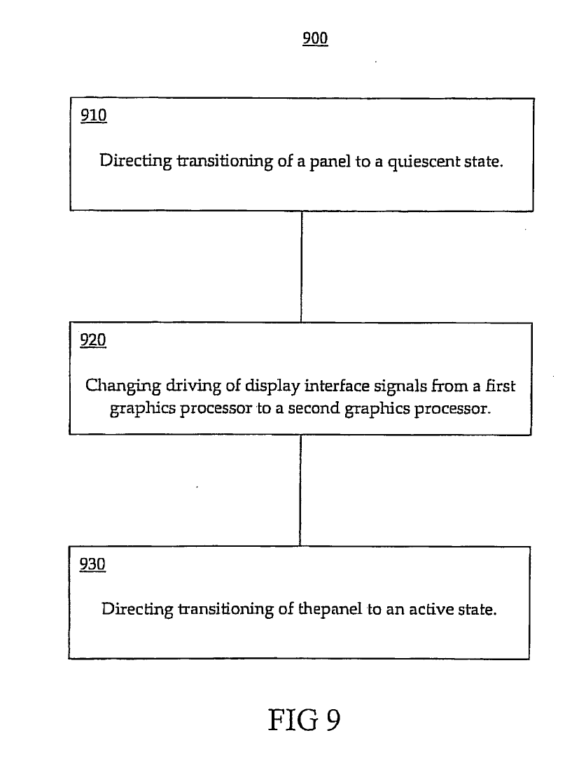

FIG. 9 is a flow chart exemplary of graphics processing unit change over process 900 in accordance with one embodiment of the present invention. In one embodiment, graphics processing unit change over process instruction are embedded on a computer readable medium. Similar to process 600 there is an agent which facilitates coordination of the process or transaction by talking to drives associated with multiple processors.

At block 910, a transition to a panel quiescent state is directed. In one embodiment, the transitioning to a quiescent state comprises performing a panel power down process. In one exemplary implementation, independent panel power sequences are utilized in the transitioning to a

The signals forwarded to a display are changed from a first graphics processor to a second graphics processor at block 920. In one embodiment, the changing signals from a first graphics processor to a second graphics processor comprises loading drivers associated with the second graphics processing unit.

At operation 930, a transition to a panel active state is directed. In one embodiment, the transitioning to an active state comprises performing a panel power up process. In one exemplary implementation, the transitioning to an active state can include utilizing.

It is appreciated that the present change over systems and methods enable each processor to control a panel power sequence in each controller's own fashion. In addition, by coordinating the LCD power enable features, the present approach facilitates reduction of possible panel control signal excursion, panel failure and possible damage associated with undeterministic timing in signals associated with the transition from one processor to another. For example, during a transition interval the time taken to re-apply valid timings on the panel interface is affected by driver software

In one embodiment, precise co-ordinated control of internal sequencing on both the integrated and discrete graphics processing units is available and the LCD power enable is kept applied while the LVDS signals are modulated. In one exemplary implementation, the mode on the other CPU is set prior to transition as set forth above. An additional hardware signal and state machine between the two CPU's is included. The additional hardware signal and state machine signal the panel power sequencing logic of the second CPU when the first CPU's transition is completed. In one embodiment, the state machine controls the MUX select in order to facilitate minimal transition time.

Thus, the present invention facilitates efficient and effective utilization of multiple processors with a display. Each process can start LVDS frame timings at a random point in time and the present processor change

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. The listing of steps within method claims do not imply any particular order to performing the steps, unless explicitly stated in the claim.

What is claimed is:

1. A dual graphics processing system comprising:
a first graphics processing unit for processing graphics information;
a second graphics processing unit for processing graphics information; and
a component for controlling switching between said first graphics processing unit and said second graphics processing unit.

2. A dual graphics processing system of claim 1 wherein said component for controlling switching between said first graphics processing unit and said second graphics processing unit comprises a multiplexer that forwards display component signals from said first graphics processing unit and said second graphics processing unit in accordance with a graphics processing unit selection indication.

3. A dual graphics processing system of claim 1 wherein said component for controlling switching between said first graphics processing unit and said second graphics processing unit comprises:
a first graphics processing unit display enable component for coordinating display component enablement indication from said first graphics processing unit with a graphics processing selection indication;
a second graphics processing unit display enable component for coordinating display component enablement indication from said second graphics processing unit with said graphics processing selection indication; and
a display component enable generation component for generating a display component enable signal in accordance with output of said first graphics processing unit display enable component and output of said second graphics processing unit display component.

4. A dual graphics processing system of claim 1 wherein said a first graphics processing unit display enable component and said second graphics processing unit display enable component are AND logic components and said display component enable generation component is an OR logic component.

5. A dual graphics processing system of claim 1 wherein said component for controlling conforms to panel power sequencing when coordinating said switching between said first graphics processing unit and said second graphics processing unit.

6. A dual graphics processing system of claim 1 wherein said first graphics processing unit is an internal graphics processing unit and said second graphics processing unit is a dedicated graphics processing unit.

7. A dual graphics processing system of claim 1 wherein a backlighting signal is driven by said internal graphics processing unit.

8. A dual graphics processing system of claim 1 wherein a panel control signal transmitted from said first graphics processing unit is utilized as a feedback event to trigger said switching to said second graphics processor.

9. A dual graphics processing system of claim 1 wherein said component for controlling switching participates in a graphics processing unit change over process comprising:
directing transitioning of a panel to a quiescent state;
changing driving of display interface signals from said first graphics processor to said second graphics processor; and
directing transitioning of said panel to an active state.

10. A dual graphics processing method comprising:
performing graphics processing on a first graphics processing unit;
forwarding results of said graphics processing from said first graphics processing unit to a display;
performing graphics processing on a second graphics processing unit; and
performing a graphics processing unit change over process in which results of said graphics processing from said second graphics processing unit are forwarded to said display instead of said results of said graphics processing from said first graphics.

11. A dual graphics processing method of claim 10 wherein said first graphics processing unit is an internal graphics processing unit and said second graphics processing unit is a discrete graphics processing unit.

12. A dual graphics processing method of claim 10 wherein said graphics processing unit change over process comprises:
performing a panel power down sequence;
changing signals forwarded to a display from a first processing unit to a second processing unit; and
performing a panel power up sequence.

13. A graphics processing unit change over process of claim 10 wherein said graphics processing unit change over process comprises:
powering up a first graphics processing unit;
checking if a second graphics processing unit is powered up;
powering up a second graphics processing unit if not already powered up; and
changing information forwarded to a display from said first graphics processing unit to said second graphics processing unit.

14. A graphics processing unit change over process of claim 10 further comprising utilizing a panel control signal transmitted from said first graphics processing unit as a feedback event to trigger said changing to a second graphics processor.

15. A computer readable medium with instruction embedded therein for directing a graphics processing unit change over process comprising:
directing transitioning of a panel to a quiescent state;
changing driving of display interface signals from a first graphics processor to a second graphics processor; and
directing transitioning of said panel to an active state.

16. A computer readable medium of claim 15 wherein said transitioning to a quiescent state comprises performing a panel power down process.

17. A computer readable medium of claim 15 wherein said transitioning to an active state comprises performing a panel power up process.

18. A computer readable medium of claim 15 wherein independent panel power sequences are utilized in said transitioning to a quiescent state and said transitioning to said active state.

19. A computer readable medium of claim 17 wherein said changing signals from a first graphics processor to a second graphics processor comprises loading drivers associated with said second graphics processing unit.

20. A graphics processing unit change over process of claim 15 wherein some of said backlight control is driven by said first graphics processing unit even after said changing of display interface signals from a first graphics processor to a second graphics process.
